(19) United States
(12) Patent Application Publication
(10) Pub. No.: US 2010/0166182 A1
(43) Pub. Date: Jul. 1, 2010

(54) METHOD AND SYSTEM FOR SECURING VOICE OVER INTERNET PROTOCOL TRANSMISSIONS

(75) Inventors: David E. Berggren, Arlington, MA (US); Kedarnath Bangalore, Wayland, MA (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES, LLC, Temple Terrace, FL (US)

(21) Appl. No.: 12/347,015

(22) Filed: Dec. 31, 2008

(51) Int. Cl. H04K 1/00

(52) U.S. Cl. 380/257

(57) ABSTRACT

An approach is provided for providing secure packetized voice transmissions. A public key corresponding to a destination device is retrieved. An input signal is digitized for transmission over a packetized voice connection to the destination device. The digitized signal is encrypted using a public key of the destination device. This encrypted input signal when received at the destination device is decrypted using a secure private key at the destination device.

### BACKGROUND INFORMATION

The popularity and convenience of the Internet has resulted in the reinvention of traditional telephony services. These services are offered over a packet switched network with minimal or no cost to the users. IP (Internet Protocol) telephony, thus, have found significant success, particularly in the long distance market. In general, IP telephony, which is also referred to as voice over IP (VOIP), is the conversion of voice information into data packets that are transmitted over an IP network. Users also have turned to IP telephony as a matter of convenience in that both voice and data services are accessible through a single piece of equipment, namely a personal computer. The continual integration of voice and data services further fuels this demand for IP telephony applications.

Undoubtedly, the Internet has revolutionized personal and business communication by providing a global medium with powerful services such as the World Wide Web, e-mail, and VOIP. The Internet is a conglomeration of numerous heterogeneous networks, which are linked through internetworking devices, without restriction on the systems that can be a part of this global network. Because of the unrestricted nature, network security issues have garnered significant attention, particularly by service providers that need to ensure timely and secure communications for their customers.

Secure handling of sensitive data has become a very important issue. Hackers have become very sophisticated in their techniques for accessing sensitive data stores. Also, with the increasing popularity of VOIP, there is an increasing potential that these hackers may intercept and use information being transmitted during VOIP sessions. As VOIP technology progresses and users are provided with ever-increasing manners in which to access and utilize VOIP communications, the need to secure data transmitted during VOIP sessions will also increase.

Therefore, there is a need for a way to secure data being transmitted during VOIP sessions.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 depicts a data network with endpoints for providing secure encryption of voice communications between users, according to an exemplary embodiment;

FIG. 2 is a flowchart of a process for initiating a communication session utilizing encrypted voice payloads, in accordance with an exemplary embodiment;

FIG. 3 depicts a process for providing secure communications by encrypting voice payloads, in accordance with an exemplary embodiment; and

FIG. 4 depicts a computer system that can be used to implement an exemplary embodiment.

### DESCRIPTION OF THE PREFERRED EMBODIMENT

A preferred system, method, and software for providing encrypted voice communications are described. In the following description, for the purposes of explanation, numerous specific details are set forth in order to provide a thorough understanding of the present invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

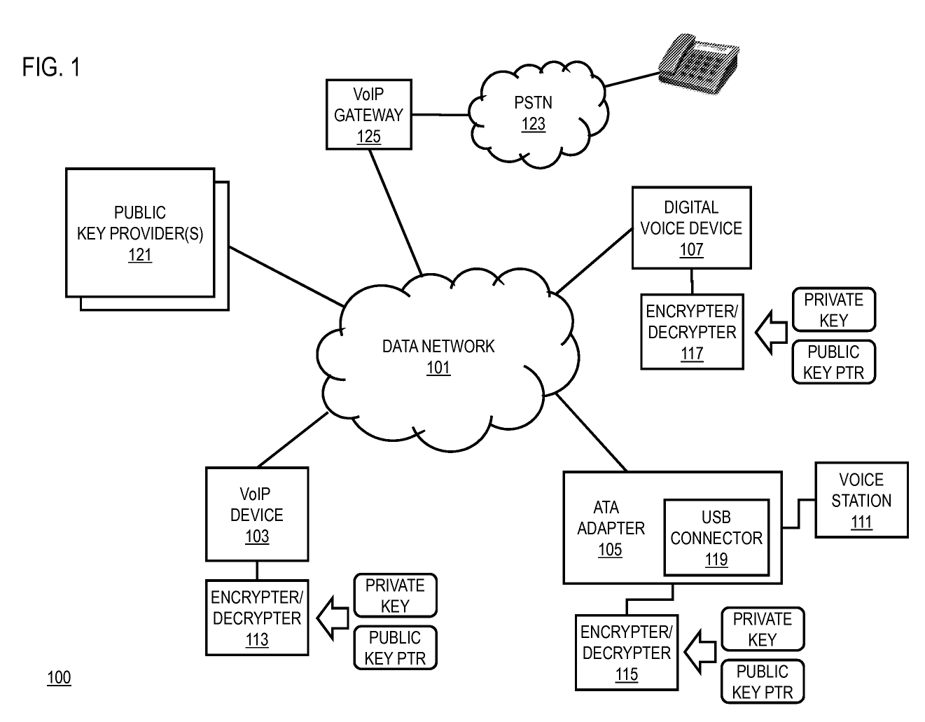

FIG. 1 depicts a data network 101 with a secure telephony system for providing secure encryption of voice communications between users, according to an exemplary embodiment. A communication system 100 includes a data network 101 that provides connectivity to a variety of devices 103, 105, and 107 capable of transmitting and receiving packetized voice flows. In this example, the devices 103, 105, and 107 include a Voice-over-Internet Protocol (VOIP) device 103, an analog terminal adapter (ATA) 105, and/or a digital voice device 107 (that can support telephony services over the data network 101). The data network 101 can include a public data network, such as the global Internet. The endpoints (i.e., “call” devices) 103, 105, and 107 can facilitate secure telephony communications among, e.g., voice stations 103, 107, and 111 through the use of encrypter/decrypter modules 113, 115, and 117, respectively; these encrypter/decrypter modules 113, 115, and 117 are capable of encrypting data streams (e.g., voice payload) being sent to the data network 101, and decrypting incoming data streams. Exemplary call devices 103, 105, and 107 include a mobile phone, wireless device, computer, etc. The analog terminal adapter (ATA) 105 performs analog-to-digital (A/D) and digital-to-analog (D/A) conversions to operate with voice station 111, which can be a traditional Plain Old Telephone Service (POTS) phone. It is contemplated that the term “endpoint” can encompass all components for providing encrypted voice payload—e.g., an ATA, VoIP phone, and/or a successor voice device.

Conventionally, VOIP phones used on the Internet pass voice traffic over the public Internet in a manner where this traffic could be captured, and listened to or recorded. For example, the traffic could flow from a POTS (or analog) phone, to an analog terminal adapter (ATA) therein, to the public Internet, to a border controller (BC), to a session initiation protocol (SIP) serving network switch, to a BC, and to either a private switched telephone network (PSTN) or to the public internet to an ATA of a second phone (or without an ATA, directly to a digital VOIP phone). In such a connection, the ATA digitizes the speech into a codec that is passed over the public internet via a SIP packet through the BC all the other points, another or the same BC, to the public internet, to the ATA device, then to the VOIP phone being called. Throughout that SIP packet's existence, any hacker that sniffs that packet off the network, can listen to and/or record the conversation.

In recognition of the above issue, the system 100 protects voice traffic from unauthorized access through the use of encryption at the end devices. By way of example, a secure voice communication session is established between a source call device, e.g., voice station 111, and a destination call device, e.g., device 103. In one embodiment, the ATA 105 of call device 111 can be provided with, for example, a Universal Serial Bus (USB) connector 119 or other removable storage medium port for inserting a flash storage device, which can contain a private key of an asymmetrical public/private key pair (and, e.g., a pointer (or identifier) to where the public key is located). Then, during session initiation at the startup of the call, the encrypter/decrypter 113 of the other party (i.e., destination call device 103) can retrieve the public key of the source call device, and utilize the public key to encrypt data being sent to the source call device. Thus, each time after, the encrypters/decrypters (also referred to as coder/decoder “codec”) 115, 117 encrypt the digitized speech using the respective public keys of the devices 103, 111. This encrypted codec using, for example, standard SIP protocol could still be sniffed, but the speech would be very difficult, if not impossible to decipher, without the corresponding private key. Once this SIP packet with the encrypted codec reached the source call device, the private key would be used to decrypt the codec into intelligible speech, which is private to the listener on the source call device.

For example, during session description setup, the originating VOIP ATA (e.g., adapter 105) can utilize a session description protocol; this protocol is detailed in Internet Engineering Task Force (IETF) Request for Comment (RFC) 4566, which is incorporated herein by reference in its entirety. In one embodiment, a uniform resource identifier (URI) can be included in the key field. The URI refers to the data containing the public key, and may require additional authentication before the key can be returned. When a request is made to the given URI, the reply should specify the encoding for the key. The URI can be a secure socket layer/transport layer security (SSL/TLS)-protected HTTP URI (“https:”), although this is not required. Use of the URI would enable the destination device to retrieve the matching public key, from the public key vendor/provider 121, via a secure socket layer, thus enabling voice payload (e.g., codecs) passed back to the originating VOIP ATA to be encrypted and secure. Similarly, the destination VOIP ATA could pass the URI back to the originating VOIP ATA, thus enabling the originating VOIP ATA or digital phone to retrieve the matching public key from the public key vendor/provider via a secure socket layer. This can occur if the destination VOIP ATA also contained a private key (which had been successfully challenged). At this point the codecs (voice traffic) in both directions would be secured by the asymmetric public key, which could only be decoded by the corresponding private key in each ATA.

According to certain embodiments, the above mechanism can be implemented between VOIP phones, since the VOIP service provider typically controls the ATA software. Thus, the necessary software can be provided, supported, and distributed to users' call devices 103, 105, and 107. The private key can be stored in the memory of the call device, or in a removable memory in flash memory that can be plugged into the call device. The call device can be equipped with a passcode, such as a user personal identification number (PIN) or password, in order to verify that the proper user is attempting to utilize the secure telephony system. For example, if the ATA determined that a USB PROM (Programmable Read-Only Memory) was connected, if a private key was stored therein, then the user would be prompted for the challenge password, and if the user passes the challenge key, then incoming voice communications could be secured.

It is noted that standard SIP utilizes transmission control protocol (TCP) or user datagram protocol (UDP) to pass traffic. Also, typical VOIP implementations use a UDP transport. There is a Secure TCP method that is not believed to have been implemented for VOIP due to the statefulness of TCP, which imposes too much overhead on the servers. The Secure TCP method has the drawback that it utilizes many secure TCP connections, which reduces throughput capacity since each server cannot support as many secure TCP connections as it can support stateless UDP connections.

With the system 100, the use of the ATA smart device at the endpoint to implement the processing of the secure telephony system in the call devices is advantageous since the ATA (e.g., adapter 105) has an economical central processing unit (CPU) with significant spare capacity; also, the CPU can be upgraded more economically than central servers. Using the spare CPU capacity of the ATA to encrypt and decrypt the codecs, advantageously provides the user (or customer) a secure communication from VOIP endpoint to VOIP endpoint. Such services can be charged to the customer for each secure phone call. An additional advantage of this enhanced configuration is that the only devices requiring modification to implement this system would be the ATA and the digital phone. Furthermore, there would be no increased demands on the VOIP network provider, and no need for secure TCP connections and its associated increased demands for CPU power.

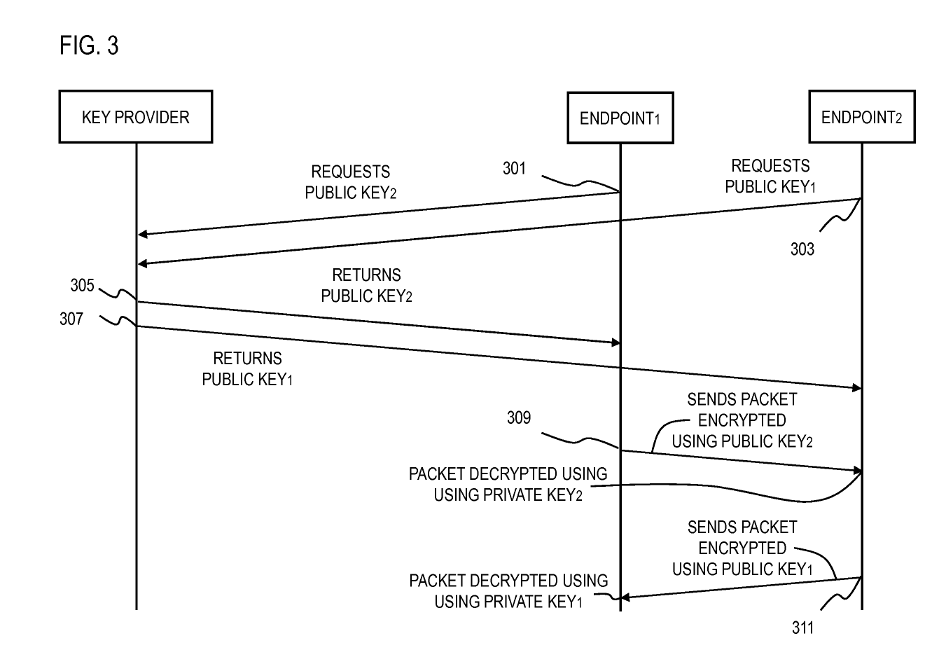

As seen in FIG. 1, the secure telephony system 100 also includes one or more public key providers 121 that can disseminate public keys to support secure communications. The public keys are supplied by the public key provider 121 to devices 103, 105, and 107; in this example, each of the devices 103, 105, and 107 utilizes a pointer (e.g., Uniform Resource Identifier (URI)) to retrieve the actual public key from the provider 121. As such, the public key provider 121 distributes the public keys to the devices 103, 105, and 107, as more fully explained in FIG. 3. With respect to the private keys, it is noted any standard key-exchange protocol (e.g., Diffie-Hellman, etc.) can be utilized to provide the devices 103, 105, and 107 with their respective private keys.

As shown, the data network 101 can also provide connectivity to a circuit-switched telephony network, e.g., PSTN (Public Switched Telephone Network) 123, via a VOIP gateway 125 to exchange unsecure voice calls.

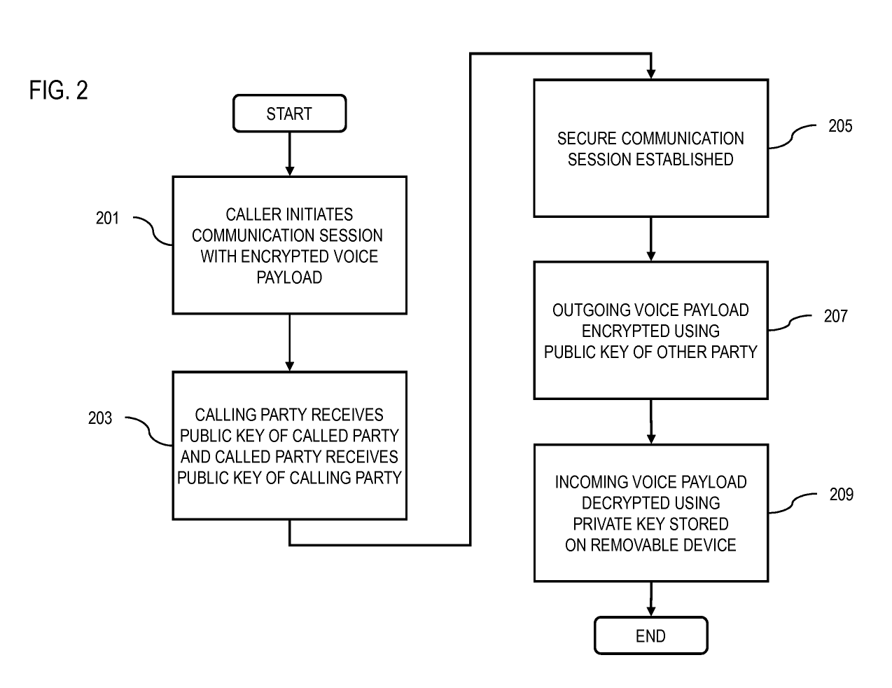

FIG. 2 is a flowchart of a process for initiating a communication session utilizing encrypted voice payloads, in accordance with an exemplary embodiment. This process illustrates a basic operation of the secure telephony service; however, this process does not set forth the details regarding how the private keys are obtained for each of the parties to the call, as such private key exchange can be performed using conventional approaches. Thus, it is assumed that each party to the call has previously received and stored their own private key for use in a secure telephony session. For example, the private key can be stored in the memory of a call device used to make the call, or the private key can be stored on a removable storage medium (e.g., a Universal Serial Bus (USB) memory device, other flash memory device, etc.) that can be utilized with various devices, such that the user can use stored private key on a number of different devices to make the call.

In step 201, a caller (or calling party), using the voice station 111 in conjunction with the ATA adapter 105, initiates a communication session over the data network 101 with a destination endpoint, e.g., digital voice device 107 (called party). This step can be performed, for example, by the caller dialing a predetermined access number, by contacting a predetermined website, etc.) or simply initiating the call directly to the other party. In the latter instance, the device used to make the call can be configured to automatically initiate establishment of the call, for example, based upon a setting on the device, or based on the detection of the presence of a private key in the memory of the device used to make the call, or other triggering mechanism.

In step 203, the respective parties request public keys from the public key provider 121, which responds with the proper keys. That is, the calling party will receive from the key provider 121 a public key of the called party, and the called party will receive a public key of the calling party. Thus, since each party has its own private key and the public key of the other party, a secure communication session can be established, whereby voice traffic can be encrypted between the voice station 111 and the digital voice device 107 (step 205). In this manner, outgoing voice payloads are encrypted using the public key of the other party, per step 207, and incoming encrypted voice payloads are decrypted using the private key party receiving the incoming packet in step 209.

Thus, for example, the calling party speaks into the voice station 111, which supplies the speech signal to the adapter 105 for digitization. Subsequently, the encrypter/decrypter 115 encrypts the digitized speech using the public key of called party. This encrypted voice payload is transmitted over the data network 101 and on to the device 107, which employs the encrypter/decrypter 117 to decrypt the received voice traffic using the stored private key. Secure voice communication is provided via the encrypter/decrypter 117 to encrypt the speech signal using the public key of the calling party. This encrypted voice traffic is transmitted to the data network 101 back to the voice station 111. Thus, the voice payload flowing in both directions via the data network 101 can be securely encrypted. It is noted the data flow (e.g., voice traffic) can be encrypted in one direction (e.g., if only one of the parties to the call is authorized); however, this would only protect data flowing in one direction (e.g., the data flow to the authorized user of the secure telephony system), which would provide limited protection to the confidentially of the call.

FIG. 3 depicts a process for providing secure communications by encrypting voice payloads, in accordance with an exemplary embodiment. In step 301, a first user sends via an Endpoint₁ (or source endpoint) a request for a public key from the key provider 121 to initiate a secure telephony session between the first user and a second user. The key provider 121 can verify the first user's authorization to request the key. The key provider 121 can subsequently supply a public key₂ to the first user. In response to the call establishment procedure, a destination endpoint, Endpoint₂, will request a corresponding public key—i.e., public key₁ of the first user—from the key provider 121, as in step 303. The key provider 121, per steps 305 and 307, will transmit public key₂ and the public key₁ to the respective requesters. In an embodiment where the public keys are associated with URLs, the public key₁ and the public key₂ are simply retrieved upon invoking these URLs.

Per steps 309 and 311, a secure telephony session can be established between the first user's call device and the second user's call device. As shown in step 309, any packet of digitized speech data sent from the first user's call device via Endpoint₁ will be encrypted using the public key₂. Such packets will then be received by Endpoint₂and decrypted using private key₂, which is stored at the second user's call device. Similarly, as shown in step 311, digitized speech data sent from the second user's call device via Endpoint₂ will be encrypted using the public key₁, and such packets will then be received by the first endpoint and decrypted using private key₁.

The described processes, according to certain embodiments, advantageously provide a scalable, efficient approach to ensuring secure telephony services using end-to-end encryption of voice payloads, while avoiding infrastructure upgrades or modifications.

The processes described herein may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

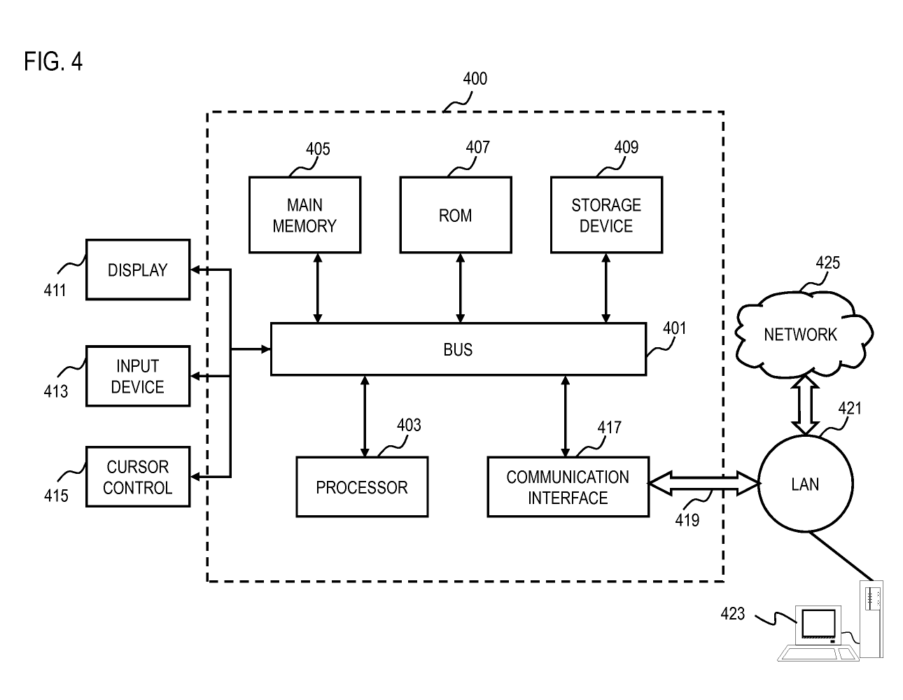

FIG. 4 illustrates computing hardware (e.g., computer system) 400 upon which an embodiment according to the invention can be implemented. The computer system 400 includes a bus 401 or other communication mechanism for communicating information and a processor 403 coupled to the bus 401 for processing information. The computer system 400 also includes main memory 405, such as a random access memory (RAM) or other dynamic storage device, coupled to the bus 401 for storing information and instructions to be executed by the processor 403. Main memory 405 can also be used for storing temporary variables or other intermediate information during execution of instructions by the processor 403. The computer system 400 may further include a read only memory (ROM) 407 or other static storage device coupled to the bus 401 for storing static information and instructions for the processor 403. A storage device 409, such as a magnetic disk or optical disk, is coupled to the bus 401 for persistently storing information and instructions.

The computer system 400 may be coupled via the bus 401 to a display 411, such as a cathode ray tube (CRT), liquid crystal display, active matrix display, or plasma display, for displaying information to a computer user. An input device 413, such as a keyboard including alphanumeric and other keys, is coupled to the bus 401 for communicating information and command selections to the processor 403. Another type of user input device is a cursor control 415, such as a mouse, a trackball, or cursor direction keys, for communicating direction information and command selections to the processor 403 and for controlling cursor movement on the display 411.

According to an embodiment of the invention, the processes described herein are performed by the computer system 400, in response to the processor 403 executing an arrangement of instructions contained in main memory 405. Such instructions can be read into main memory 405 from another computer-readable medium, such as the storage device 409. Execution of the arrangement of instructions contained in main memory 405 causes the processor 403 to perform the process steps described herein. One or more processors in a multi-processing arrangement may also be employed to execute the instructions contained in main memory 405. In alternative embodiments, hard-wired circuitry may be used in place of or in combination with software instructions to implement the embodiment of the invention. Thus, embodiments of the invention are not limited to any specific combination of hardware circuitry and software.

The computer system 400 also includes a communication interface 417 coupled to bus 401. The communication interface 417 provides a two-way data communication coupling to a network link 419 connected to a local network 421. For example, the communication interface 417 may be a digital subscriber line (DSL) card or modem, an integrated services digital network (ISDN) card, a cable modem, a telephone modem (so long as the rate supports real-time packetized voice traffic), or any other communication interface to provide a data communication connection to a corresponding type of communication line. As another example, communication interface 417 may be a local area network (LAN) card (e.g. for Ethernet™ or an Asynchronous Transfer Model (ATM) network) to provide a data communication connection to a compatible LAN. Wireless links can also be implemented. In any such implementation, communication interface 417 sends and receives electrical, electromagnetic, or optical signals that carry digital data streams representing various types of information. Further, the communication interface 417 can include peripheral interface devices, such as a Universal Serial Bus (USB) interface, a PCMCIA (Personal Computer Memory Card International Association) interface, etc. Although a single communication interface 417 is depicted in FIG. 4, multiple communication interfaces can also be employed.

The network link 419 typically provides data communication through one or more networks to other data devices. For example, the network link 419 may provide a connection through local network 421 to a host computer 423, which has connectivity to a network 425 (e.g. a wide area network (WAN) or the global packet data communication network now commonly referred to as the “Internet”) or to data equipment operated by a service provider. The local network 421 and the network 425 both use electrical, electromagnetic, or optical signals to convey information and instructions. The signals through the various networks and the signals on the network link 419 and through the communication interface 417, which communicate digital data with the computer system 400, are exemplary forms of carrier waves bearing the information and instructions.

The computer system 400 can send messages and receive data, including program code, through the network(s), the network link 419, and the communication interface 417. In the Internet example, a server (not shown) might transmit requested code belonging to an application program for implementing an embodiment of the invention through the network 425, the local network 421 and the communication interface 417. The processor 403 may execute the transmitted code while being received and/or store the code in the storage device 409, or other non-volatile storage for later execution. In this manner, the computer system 400 may obtain application code in the form of a carrier wave.

The term “computer-readable medium” as used herein refers to any medium that participates in providing instructions to the processor 403 for execution. Such a medium may take many forms, including but not limited to non-volatile media, volatile media, and transmission media. Non-volatile media include, for example, optical or magnetic disks, such as the storage device 409. Volatile media include dynamic memory, such as main memory 405. Transmission media include coaxial cables, copper wire and fiber optics, including the wires that comprise the bus 401. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the invention has been described in connection with a number of embodiments and implementations, the invention is not so limited but covers various obvious modifications and equivalent arrangements.

1. A method comprising:
retrieving a public key corresponding to a destination device;
digitizing an input signal for transmission over a packetized voice connection to the destination device; and
encrypting the digitized signal using a public key of the destination device.

2. A method according to claim 1, further comprising:
receiving an encrypted voice stream from the destination device, wherein the voice stream being encrypted using another public key; and
decrypting the encrypted voice stream using a private key corresponding to the other public key.

3. A method according to claim 2, further comprising:
retrieving the private key from a removable storage medium.

4. A method according to claim 1, further comprising:
initiating a call establishment procedure with the destination device; and
requesting the public key from a public key provider in response to the initiation of the call establishment procedure.

5. A method according to claim 1, wherein the packetized voice connection is established using a Session Initiation Protocol (SIP).

6. A method according to claim 1, wherein the public key is assigned a public key pointer for use in the retrieval of the public key.

7. A method according to claim 6, wherein the public key pointer includes a uniform resource identifier (URI).

8. A method according to claim 1, further comprising:
interfacing with a voice station to receive the input signal.

9. An adapter apparatus comprising:
a communication interface configured to retrieve a public key corresponding to a destination device;
a processor configured to digitize an input signal for transmission over a packetized voice connection to the destination device; and
an encrypter configured to encrypt the digitized signal using a public key of the destination device.

10. An apparatus according to claim 9, wherein the communication interface is further configured to receive an encrypted voice stream from the destination device, and the voice stream being encrypted using another public key, the apparatus further comprising:
a decrypter configured to decrypt the encrypted voice stream using a private key corresponding to the other public key.

11. An apparatus according to claim 10, further comprising:
a port configured to receive a removable storage medium that is configured to store the private key.

12. An apparatus according to claim 9, wherein the processor is further configured to initiate a call establishment procedure with the destination device, and to request the public key from a public key provider in response to the initiation of the call establishment procedure.

13. An apparatus according to claim 9, wherein the packetized voice connection is established using a Session Initiation Protocol (SIP).

14. An apparatus according to claim 9, wherein the public key is assigned a public key pointer for use in the retrieval of the public key.

15. An apparatus according to claim 14, wherein the public key pointer includes a uniform resource identifier (URI).

16. An apparatus according to claim 9, further comprising:
a device interface configured to interface with a voice station to receive the input signal.

17. A method comprising:
receiving a first request for a first public key from a first call device;
receiving a second request for a second public key from a second call device, wherein the first call device has initiated a secure telephony session with the second call device; and
transmitting the first public key to the first call device and the second public key to the second call device for use in encrypting voice traffic associated with the secure telephony session.

18. A method according to claim 17, wherein each of the call devices is configured to retrieve corresponding private keys from respective removable storage media for decryption of the encrypted voice traffic.

19. A method according to claim 17, wherein the public keys are assigned public key pointers for use in the retrieval of the public keys.

20. A method according to claim 19, wherein the public key pointers includes uniform resource identifiers (URIs) or uniform resource locators (URLs).
